(19) United States
(12) Patent Application Publication
(10) Pub. No.: US 2003/0084624 A1
(43) Pub. Date: May 8, 2003

(54) JOINT STRUCTURE AS REINFORCING RIB TO INJECTED FRAME OF DOOR LEAF WITH GLASS

(76) Inventor: Kuei Yung Wang Chen, Taipei (TW)

Correspondence Address: STEVENS, DAVIS, MILLER & MOSHER, L.L.P., Suite 850, 1615 L Street, N.W., Washington, DC, 20036, US

(21) Appl. No.: 09/985,815

(22) Filed: Nov. 6, 2001

(51) Int. Cl. E06B 3/66

(52) U.S. Cl. 52/204.59; 52/204.591; 52/204.6

(57) ABSTRACT

The present invention relates to the improvement on the assembly structure of door leaf with glass, and more particularly relates to the halving structure of two halving injected frames having the same structure with glass. The back-side circumferences of the halving injected frames with glass have a plurality of male tenons and female tenons which are disposed correspondingly each other top-to-bottom and left-to-right. By using the structures of male tenon and female tenon and the design of integrally surrounding reinforcing rib, the halving injected frame with glass has U-shape male tenon reinforcing rib and U-shape female tenon reinforcing rib so as to strengthen the strength of the having injected frame with glass; therefore, two halving injected frames (having the same structure) with glass joint each other by male tenons and female tenons to fix a multiple-layer glass, which is then held on a door leaf to quickly assemble a door leaf with glass without the need of joint members such as screws.

While the two halving injected frames (having the same structure) with glass joint each other to assemble and compose a door leaf with glass, each tenon rib of male tenons is tenoned into the tenon groove of a female tenon respectively to reach the first positioning effect; by a successive and further tenoning, the female tenon head of the female tenon is tenoned into the positioning groove of male tenon and the tenon nose of the male tenon is tenoned into the positioning groove of the female tenon so as to accomplish the second positioning and tenoning fix effect.

Therefore, the male tenon and the female tenon of the halving injected frame with glass designed by the present invention not only have novelty in structure, but also have a duplex positioning effect.

### BACKGROUND OF THE PRESENT INVENTION

1. Field of the Present Invention

The present invention relates to the improvement on the assembly structure of door leaf with glass; and more particularly relates to the halving structure of two halving injected frames (having the same structure) with glass. The back-side circumferences of the halving injected frames with glass have a plurality of male tenons and female tenons which are disposed correspondingly each other top-to-bottom and left-to-right. By using the structures of male tenon and female tenon and the design of integrally surrounding reinforcing rib, the halving injected frame with glass has U-shape male tenon reinforcing rib and U-shape female tenon reinforcing rib so as to strengthen the having injected frame with glass; therefore, two halving injected frames (having the same structure) with glass joint each other by male tenons and female tenons so as to halvingly fix a multiple-layer glass, which is then held on a door leaf to quickly assemble a door leaf with glass without the need of joint members such as screws.

2. Description of Prior Art

In the technical field of assembling door leaf with glass, screws are traditionally used as joint member of assembling glass; this is well known. However, by the improving of technique, the skill of composing the door leaf by using screws to joint and assemble glass will be obsolete gradually due to the following shortcomings:

(1) The injected frame for fixing the glass needs to use two molds simultaneously while molded, which causes a high cost.

(2) One side of the injected frame with glass has holes, the other side has no holes, which is troublesome while installing to identify indoor side or outdoor side.

(3) The holes of injected frame with glass need to be plugged in with a plug which not only is easy to fall off but also needs to use extra mold.

(4) It is required to use silicon in advance, joint with screws and then plug in the plug; procedures are complicated.

(5) Jointing procedure needs to be finished before packaging and delivering to prevent the silicon from damaging the coated surface.

In addition, said injected frame for fixing the glass traditionally uses a point reinforcing rib to solve the problem of lack of strength. This method remains to be improved despite of its capability, more or less, of strengthening the injected frame for fixing the glass; a reinforcing rib which integrally surrounds the injected frame with glass, for example, has much better reinforcing strength effect than that of point reinforcing rib.

### SUMMARY OF THE PRESENT INVENTION

In view of disadvantages of the structure of the traditional door leaf with glass, which joints and assembles the glass by screws, the present invention researches and develops, depending on years of experience on manufacturing door leaf comprising its assembling structure and fittings, a new structure of fixing the injected frame with glass by halving in order to solve problems derived by traditional screw joint structure. Meanwhile, the reinforcing rib of the present invention uses a reinforcing rib which integrally surrounds the injected frame with glass in order to strengthen the halving injected frame with glass, which makes the present invention have an U-shape male tenon reinforcing rib and an U-shape female tenon reinforcing rib.

The primary purpose of the present invention is to make the back-side circumferences of the halving injected frames with glass have a plurality of male tenons and female tenons which are disposed correspondingly each other top-to-bottom and left-to-right; two halving injected frames (having the same structure) with glass joint each other by male tenons and female tenons so as to halvingly fix a multiple-layer glass, which is then held on a door leaf to quickly assemble a door leaf with glass without the need of joint members such as screws, which saves assembling time and decreases cost.

The secondary purpose of the present invention is to make the structure of male tenons and female tenons of the halving injected frame have a duplex positioning effect. While the two halving injected frames having the same structure) with glass joint each other to assemble and compose a door leaf with glass, each tenon rib of male tenons is tenoned into the tenon groove of a female tenon respectively to reach the first positioning effect; by a successive and further tenoning, the female tenon head of the female tenon is tenoned into the positioning groove of male tenon and the tenon nose of the male tenon is tenoned into the positioning groove of the female tenon so as to accomplish the second positioning and tenoning fix effect.

The furthermore purpose of the present invention is to use the structures of male tenon and female tenon to form an U-shape male tenon reinforcing rib and U-shape female tenon reinforcing rib by integrally surrounding the injected frame with glass so as to strengthen the integral strength of the having injected frame with glass.

### BRIEF DESCRIPTION OF THE DRAWING FIGURES

FIG. 1 is a disassembling structure drawing of a door leaf with glass of the present invention, wherein two halving injected frames (having the same structure) with glass are shown.

FIG. 2 is a vertical section assembly drawing of a door leaf with glass of the present invention.

FIG. 3 is side view drawing and section drawing of a halving injected frame with glass of the present invention, which show the shape structure of the halving injected frames with glass having a plurality of male tenons and female tenons disposed correspondingly each other top-to-bottom and left-to-right and the shape structure of U-shape male tenon reinforcing rib and U-shape female tenon reinforcing rib with a design of-integrally surrounding.

FIG. 4 shows an integrally surrounding U-shape male tenon reinforcing rib composed by the structure of footing rib and tenon rib of the male tenon, and an integrally surrounding U-shape female tenon reinforcing rib composed by the structure of leading rib of the present invention.

### DETAILED DESCRIPTION OF THE PREFERRED EMBODIMENTS

The characteristics and functions of the present invention and its preferred embodiment are described as follows (accompanied by its drawings):

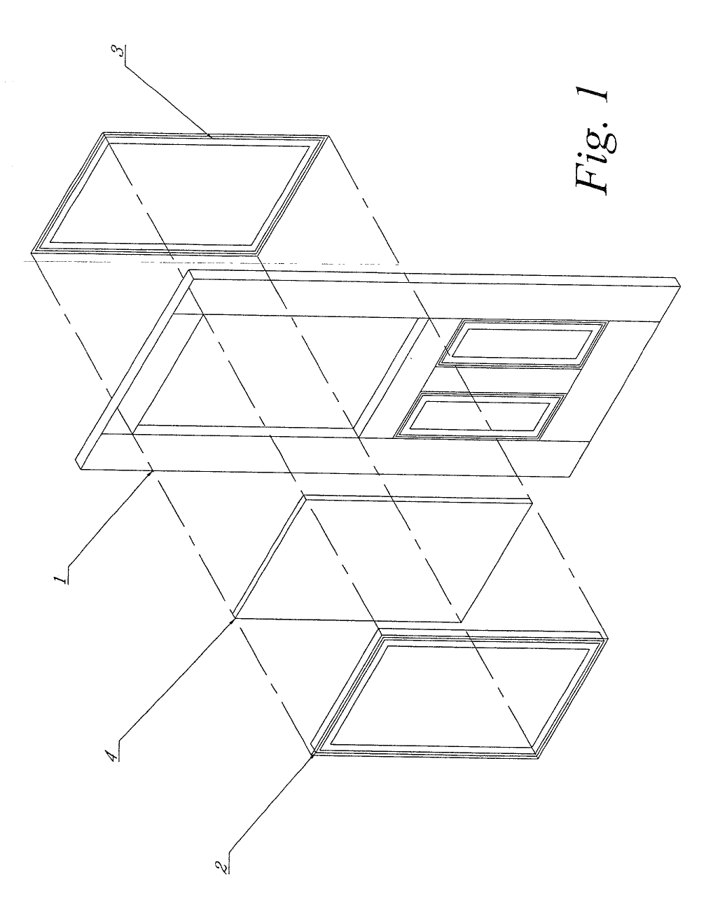

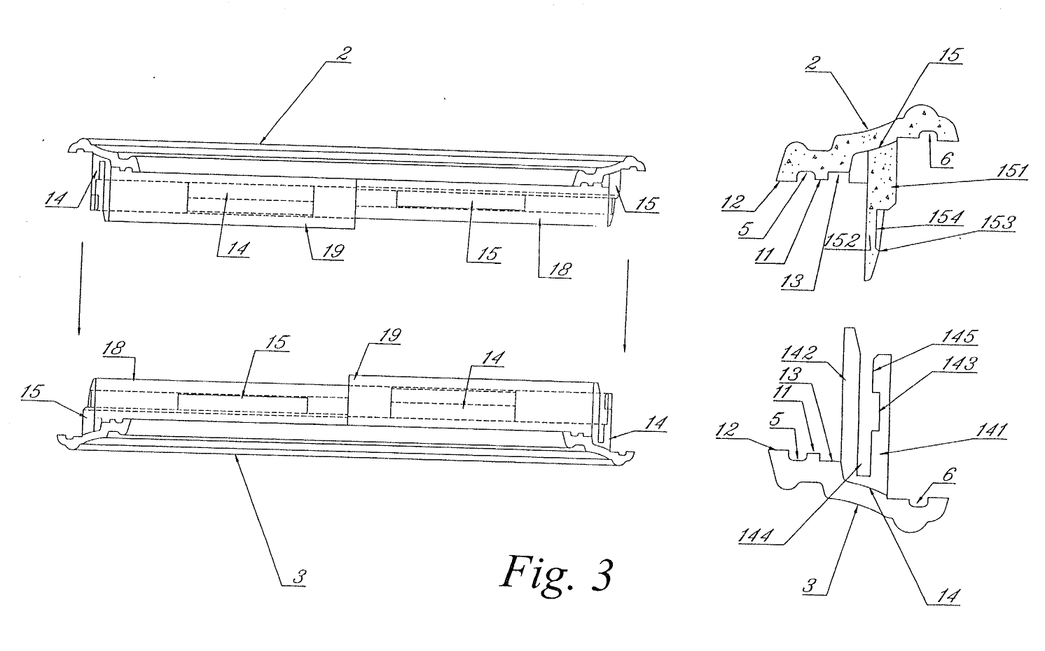

Referring to FIG. 1, the door leaf with glass disclosed by the present invention comprises a main door leaf (1) of which the shape is rectangular and there is an opening for installing glass (4), two halving injected frames (2), (3) having the same structure (also referring to FIG. 3), a plurality of male tenons (15) and a plurality of female tenons (14) which are located on each inner edge of each circumference of the halving injected frames and are disposed correspondingly top-to-bottom and left-to-right so as to make both the halving injected frames (2), (3) combine each other by male tenons (15) and female tenons (14), and a multiple-layer glass (4).

The opening of the main door leaf (1), which is for installing the multiple-layer glass (4), is cut by using computer numerical control (CNC) machine; therefore, the shape of the opening can be various such as square, rectangular, circle, ellipse, or semicircle. So, the shape of the multiple-layer glass which is going to be installed in the opening of the main door leaf needs to be as well manufactured into various outlines correspondingly such as square, rectangular, circle, ellipse, or semicircle.

Referring to FIG. 3, two halving injected frames (2), (3) having the same structure are identical products which are inject-molded or extrusion-molded by an identical mold to be frames with an opening in their centers; therefore, the halving injected frame (2) or (3) has an outline having an inner edge and an outer edge. In addition, the material of the halving injected frame (2) or (3) can be selected from wood powder, aluminum, polystyrene, polyvinyl chloride, mixture of polyvinyl chloride and wood powder, polypropylene, or mixture of polypropylene and glass fiber; meanwhile, the surface of the halving injected frame (2) or (3) can be manufactured to a smooth surface or a vein-like surface.

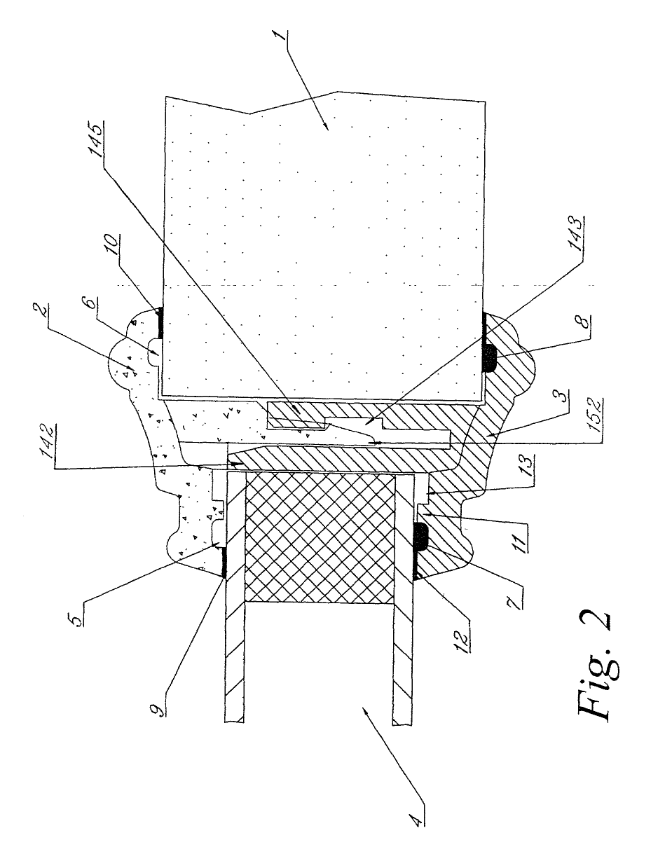

Referring to FIG. 2 and FIG. 3, the inner edge frame surface, which is at the rear side near the edge of the inner side of the halving injected frame (2) or (3), bulges along the overall inner edge outline to form an inner rib part (12) having a smooth surface; and the position, which is a little bit distant from and is parallel to the inner rib part (12), bulges as well along the overall outline of the halving injected frame (2) or (3) to form an intermediate rib part (11) having a smooth surface. However, the height of the bulged surface of the intermediate rib part (11) is lower than that of the inner rib part (12); the difference between these two heights is about 0.5 mm. Consequently, the area between the inner rib part (12) and the intermediate rib part (11) forms a valley which surrounds the overall halving injected frame (2) or (3) to compose a groove (5). And a space, which is next to the other side of the intermediate rib part (11), forms a flat surface (13) against the bulged height of the intermediate rib part (11) and surrounds the overall outline of the halving injected frame (2) or (3).

Also referring to FIG. 2 or FIG. 3, the outer edge frame surface, which is at the rear side near the edge of the outer side of the halving injected frame (2) or (3), is formed by extending inclinedly outward from the inner edge frame surface where a groove (5) is formed. On said outer edge frame surface, another groove (6) is formed along the outer edge outline with the same way as the groove (5) on the inner edge frame surface is formed.

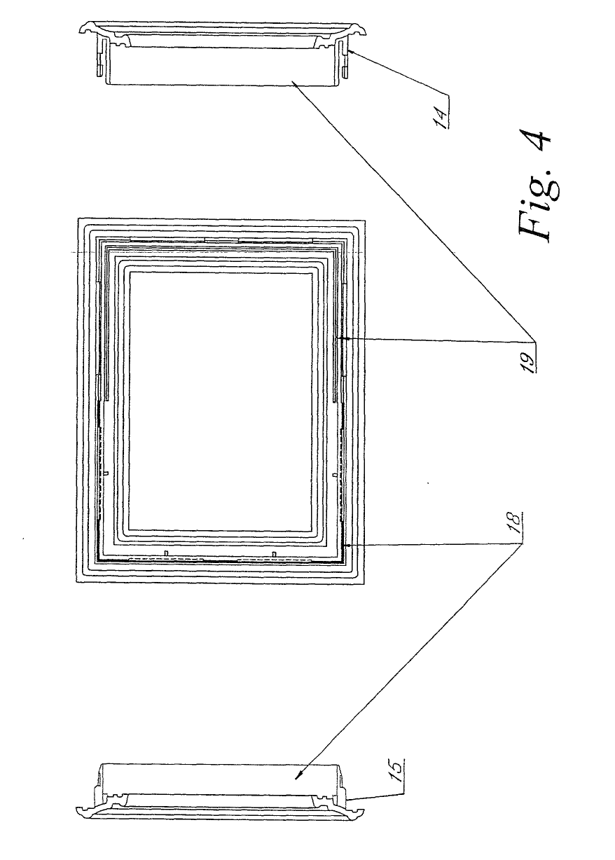

Referring to FIG. 3 and Fig.4, the position, which is located on rear side of the circumference of the halving injected frame (2) or (3) and is also located in the middle of the inner edge frame surface and the outer edge frame surface, extends upwards to form a plurality of male tenons (15) and a plurality of female tenons (14) which correspond with each other top-to-bottom and left-to-right.

The male tenon (15), whcih is a tongue with rectangular shape, comprises a footing rib (151) and a tenon rib (152). The footing of the footing rib (151) is connected to the rear side of the halving injected frame (2) or (3), and the tenon rib (152) is superposed on the top of the footing rib (151); i.e., a thinner rib plate extends vertically from the top of the footing rib (151) to compose said tenon rib (152). At near the front end of the tenon rib (152), a tenon nose (153) bulges at a direction vertical to that of tenon rib (152) not only to make the front end of the tenon rib (152) form an inclined surface so as to supply a convenient way for the tenon rib (152) to halve or disassemble with the female tenon (14) by using said inclined surface, but also to make the space between the tenon nose (153) of the tenon rib (152) and the top of the footing rib (151) form a positioning groove (154) of the male tenon (15) so as to supply a room to accommodate the female tenon head (145) of the female tenon.

The female tenon (14) comprises a fixing rib (141) and a leading rib (142). The footings of the fixing rib (141) and the leading rib (142) all connect to the rear side of the halving injected frame (2) or (3). The fixing rib (141) and the leading rib (142) are disposed in a distance which forms a tenon groove (144) of the female tenon (14) to supply a room to accommodate the tenon rib (152) of the male tenon (15). Since the length of the leading rib (142) is longer than that of the fixing rib (141), the front end of the leading rib on the tenon groove (144) side forms an inclined surface to have the outlet of the tenon groove (144) of the female tenon (14) form an enlarged shape in order to make the tenon rib (152) of the male tenon (15) be conveniently led into the tenon groove (144) of the female tenon (14). The intermediate area, on the tenon groove (144) side, of the fixing rib (141) forms a notched space which composes a positioning groove (143) of the female tenon (14), which makes the front end of the fixing rib (141) next to the positioning groove (143) form a female tenon head (145). The length of the female tenon head (145) is corresponding to the width of the positioning groove (154) of the male tenon (15); therefore, while the male tenon (15) and the female tenon (14) halve each other, the tenon rib (152) of the male tenon (15) is inserted into the tenon groove (144) of the female tenon (14), and the female tenon head (145) of the female tenon (14) is inserted into the positioning groove (154) of the male tenon (15); in addition, the tenon nose (153) of the male tenon (15) is inserted into the positioning groove (143) of the female tenon (14); therefore, the bulged nose (153) of the male tenon (15) is held and fixed at the interface of the female tenon head (145) and the positioning groove (143) of the female tenon (14).

Therefore, by attaching the rear side of the halving injected frame (3) to the rear side of the halving injected frame (2), the tenon rib (152) of the male tenon (15) of each frame is tenoned each other into the corresponding tenon groove (144) of the female tenon (14) to accomplish the primary positioning effect; then continuously attach them closer so as to make the female tenon head (145) of the female tenon (14) be tenoned into the positioning groove (154) of the male tenon (15) and make the tenon nose (153) of the male tenon (15) be inserted into the positioning groove (143) of the female tenon (14) to accomplish the secondary positioning effect. Through said duplex positioning effect, the halving injected frame (2) and the halving injected frame (3) are held on each other, and are assembled with the main door leaf (1) and the multiple-layer glass (4) into one body so as to compose a door leaf with glass.

Again referring to FIG. 3 and FIG. 4, in order to reinforce the integral strength of the halving injected frame (2) and the halving injected frame (3), the present invention uses the structure of the footing rib (151) and the tenon rib (152) of the male tenon (15) and the structure of the leading rib (142) of the female tenon (14), and designs an integrally surrounding ribs which respectively surround the bottom half path and the upper half path of the rear sides of the frames of the injected frame (2) and the halving injected frame (3) so as to respectively compose an U-shape male tenon reinforcing rib (18) and an U-shape female tenon reinforcing rib (19). Meanwhile, the U-shape male tenon reinforcing rib (18) and the U-shape female tenon reinforcing rib (19) are integrally surrounding ribs which not only accomplish an effect of positioning the multiple-layer glass (4) but also solve the past problem of lacking of strength caused by using point reinforcing rib.

Referring to FIG. 2, the assembling procedures of the door leaf with glass disclosed by the present invention are described as follows:

(a) Select one from the halving injected frames (2), (3) (for the sake of convenient description, the halving injected frame (2) is selected as an example), then fill silicon (7) in the groove (5) on the inner edge frame surface of the halving injected frame (2) so as to obtain good sealing effect while installed with the multiple-layer glass (4); similarly, fill silicon (8) in the groove (6) on the outer edge frame surface of the halving injected frame (2).

(b) Attach the halving injected frame (2) to the opening (used for installing the multiple-layer glass (4)) of the main door leaf (1), the main door leaf (1) is adhesion-combined by using the silicon (8) which is filled in the groove (6) on the outer edge frame surface of the halving injected frame (2) so as to make the surfaces at both sides of the groove (6) on the outer edge frame surface of the halving injected frame (2) closely adhere to the surface of the main door leaf (1). While a reinforced water-proof effect is required, the outer-side surface of the groove (6) on the outer edge frame surface of the rear side of said halving injected frame (2) can be secondary-injected to form a soft pad (10) in order to obtain better sealing effect while adhesion-combined to the main door leaf (1).

(c) Next, attach a piece or a plurality of pieces of multiple-layer glass (4), of which the shape is similar to that of the opening of the main door leaf (1) but the size is a little smaller, to the halving injected frame (2) so as to not only make the weight of the multiple-layer glass (4) be supported by the U-shape female tenon reinforcing rib (19) of the halving injected frame (2), but also make the silicon (7) which is filled in the groove (5) on the inner edge frame surface of the halving injected frame (2) adhesion-combine with the glass (4). Since the height of the bulged surface of the intermediate rib part (11) of the inner edge frame surface of the halving injected frame (2) is about 0.5 mm lower than that of the bulged surface of the inner rib part (12), a little bit of seam is kept between said intermediate rib part (11) and the glass (4); therefore, when the glass (4) and the halving injected frame (2) are pressed to closely adhesion-combined, part of the silicon (7) filled in the groove (5) will flow, due to being pressed, through the seam between the intermediate rib part (11) and the glass (4) into the space of the flat surface (13) at the other side of the intermediate rib part (11), which makes the glass (4) be closely adhesion-combined with the surface of the inner edge frame surface of the halving injected frame (2). While a reinforced water-proof effect is required, the outer-side surface of the groove (5) on the inner edge frame surface of the rear side of said halving injected frame (2) can be secondary-injected to form a soft pad (9) in order to obtain better sealing effect while adhesion-combined to the main door leaf (4).

(d) Moreover, the other halving injected frame (3) is assembled with the same manner as that of said halving injected frame (2) and main door leaf (1) and glass (4); first, fill silicon (7) in the groove (5) on the inner edge frame surface, then fill silicon (8) in the groove (6) on the outer edge frame surface. In order to obtain a reinforced water-proof effect, the outer-side surface of the groove (5) on the inner edge frame surface and the outer-side surface of the groove (6) on the outer edge frame surface of the halving injected frame (3) can be secondary-injected to form soft pads (9) and (10); thereafter, attach the halving injected frame (3) to the other side of the opening of the main door leaf (1) and attach the rear side of the halving injected frame (3) to the rear side of said halving injected frame (2) in such way that the tenon rib (152) of the male tenon (15) of each frame is tenoned each other into the corresponding tenon groove (144), then continuously attach them closer so as to make the female tenon head (145) of the female tenon (14) be tenoned into the positioning groove (154) of the male tenon (15) and make the tenon nose (153) of the male tenon (15) be tenoned into the the positioning groove (143) of the female tenon (14) in order to make both frames be held each other on the main door leaf (1) and to make the multiple-layer glass (4) be supported and positioned by the U-shape female tenon reinforcing rib (19), by which time, the door leaf assembly with glass disclosed by the present invention is completed.

As described above, the structure of the joint structure as reinforcing rib to halving injected frame of door leaf with glass is of novelty, usefulness, and improvement, which fulfills what are required for being granted a patent by the Patent Law.

What is claimed is:

1. A joint structure as reinforcing rib to halving injected frame of door leaf with glass, comprising:
a main door leaf with a rectangular shape and an opening for installing glass;
two halving injected frames having the same structure with glass, wherein each of frames has an inner opening; the outer edge frame surface, which is at the rear side near the edge of the outer side of the halving injected frame, is formed by extending and bevel outwards from the inner edge frame surface which is near the inner edge; in addition, on said outer edge frame surface, a groove is formed along the outline of the frame; and a position on the outer side surface of the inner edge frame surface bulges along the overall frame outline to form an inner rib part having a smooth surface; and a position, which is a little bit distant from and is parallel to the inner rib part, bulges as well to form an intermediate rib part having a smooth surface, which makes the said inner edge frame surface have a groove as well; and a space, which is next to the other side of the intermediate rib part, forms a flat surface; and the position, which is located in the middle of said inner edge frame surface and said outer edge frame surface, extends upwards to form a plurality of male tenons and a plurality of female tenons which correspond with each other top-to-bottom and left-to-right; said male tenons and said female tenons can be tenoned each other; and
at least one piece of glass, of which the shape is similar to that of the opening of the main door leaf, but the size is a little smaller;
wherein said male tenon is similar to a tongue with rectangular shape, of which the footing is a footing rib connected to said halving injected frame with glass, and of which a tenon rib is superposed on the top of and is thinner than said footing rib; at near the front end of said tenon rib, a tenon nose forms to make a notched space between said tenon nose of said tenon rib and the top of said footing rib to compose a positioning groove of the male tenon to supply a room to accommodate the female tenon head of the female tenon; and
said female tenon is composed of a fixing rib and a leading rib of which the footings all connect to the halving injected frame with glass; said fixing rib and said leading rib are disposed in a distance which forms a tenon groove of said female tenon; and the intermediate area, on the tenon groove side, of said fixing rib forms a notched space which composes a positioning groove of said female tenon, which makes the front end of the fixing rib form a female tenon head.

2. The joint structure as reinforcing rib to halving injected frame of door leaf with glass as defined by claim 1, wherein the structure of said footing rib and said tenon rib of said male tenon is used to form an integrally surrounding U-shape male tenon reinforcing rib, and the structure of said leading rib of said female tenon is used to form an integrally surrounding U-shape female tenon reinforcing rib; while two halving injected frames with glass halve each other, said tenon rib of said male tenon is inserted into said tenon groove of said female tenon, and said female tenon head at the front end of said fixing rib of said female tenon is inserted into the positioning groove of said male tenon; in addition, said tenon nose of said male tenon is inserted into the positioning groove of said female tenon and is held and fixed by the fixing rib of said female tenon on the side where said female tenon head has an interface with said positioning groove.

3. The joint structure as reinforcing rib to halving injected frame of door leaf with glass as defined by claim 1, wherein a tenon nose is formed in the front end of said tenon rib to make the front end of said tenon rib form an inclined surface to supply a convenient way for said tenon rib to halve or disassemble with said female tenon by using said inclined surface at the front end.

4. The joint structure as reinforcing rib to halving injected frame of door leaf with glass as defined by claim 2, wherein a tenon nose is formed in the front end of said tenon rib to make the front end of said tenon rib form an inclined surface to supply a convenient way for said tenon rib to halve or disassemble with said female tenon by using said inclined surface at the front end.

5. The joint structure as reinforcing rib to halving injected frame of door leaf with glass as defined by claim 1, wherein the length of said leading rib is longer than that of said fixing rib, and the front end of said leading rib forms an inclined surface to have the outlet of said tenon groove of said female tenon form an enlarged shape to make said tenon rib of said male tenon be conveniently led into said tenon groove of said female tenon.

6. The joint structure as reinforcing rib to halving injected frame of door leaf with glass as defined by claim 2, wherein a tenon nose is formed in the front end of said tenon rib to make the front end of said tenon rib form an inclined surface to supply a convenient way for said tenon rib to halve or disassemble with said female tenon by using said inclined surface at the front end.

7. The joint structure as reinforcing rib to halving injected frame of door leaf with glass as defined by claim 1, wherein the height of the bulged surface of said intermediate rib part of said inner edge frame surface of said halving injected frame with glass is lower than that of said inner rib part about 0.5 mm.

8. The joint structure as reinforcing rib to halving injected frame of door leaf with glass as defined by claim 2, wherein the height of the bulged surface of said intermediate rib part of said inner edge frame surface of said halving injected frame with glass is lower than that of said inner rib part about 0.5 mm.

9. The joint structure as reinforcing rib to halving injected frame of door leaf with glass as defined by claim 1, wherein the shape of said opening of said main door leaf for installing glass can be square, rectangular, circle, ellipse, or semicircle.

10. The joint structure as reinforcing rib to halving injected frame of door leaf with glass as defined by claim 2, wherein the shape of said opening of said main door leaf for installing glass can be square, rectangular, circle, ellipse, or semicircle.

11. The joint structure as reinforcing rib to halving injected frame of door leaf with glass as defined by claim 1, wherein the material of the halving injected frame with glass is selected from one of the following materials: wood powder, aluminum, polystyrene, polyvinyl chloride, mixture of polyvinyl chloride and wood powder, polypropylene, or mixture of polypropylene and glass fiber.

12. The joint structure as reinforcing rib to halving injected frame of door leaf with glass as defined by claim 2, wherein the material of the halving injected frame with glass is selected from one of the following materials: wood powder, aluminum, polystyrene, polyvinyl chloride, mixture of polyvinyl chloride and wood powder, polypropylene, or mixture of polypropylene and glass fiber.

13. The joint structure as reinforcing rib to halving injected frame of door leaf with glass as defined by claim 1, wherein the surface of the halving injected frame with glass can be a smooth surface or a vein-like surface.

14. The joint structure as reinforcing rib to halving injected frame of door leaf with glass as defined by claim 2, wherein the surface of the halving injected frame with glass can be a smooth surface or a vein-like surface.

15. The joint structure as reinforcing rib to halving injected frame of door leaf with glass as defined by claim 1, wherein said inner rib part on said inner edge frame surface or the surface beside said groove on the outer edge frame surface of the rear side of the halving injected frame can be provided with a soft pad.

16. The joint structure as reinforcing rib to halving injected frame of door leaf with glass as defined by claim 2, wherein said inner rib part on said inner edge frame surface or the surface beside said groove on the outer edge frame surface of the rear side of the halving injected frame can be provided with a soft pad.
